(19) United States
(12) Patent Application Publication
(10) Pub. No.: US 2026/0159160 A1
(43) Pub. Date: Jun. 11, 2026

(54) DRIVING SUPPORT DEVICE, DRIVING SUPPORT METHOD, AND NON-TRANSITORY RECORDING MEDIUM

(71) Applicants: TOYOTA JIDOSHA KABUSHIKI KAISHA, Aichi-ken (JP); DENSO CORPORATION, Aichi-pref (JP)

(72) Inventor: Kumiko TASHIRO, Numazu-shi (JP)

(21) Appl. No.: 19/370,758

(22) Filed: Oct. 28, 2025

(30) Foreign Application Priority Data
Dec. 9, 2024 (JP) 2024-214484

(51) Int. Cl. B62D 15/02; G08G 1/16

(52) U.S. Cl. CPC B62D 15/0265; G08G 1/165; G08G 1/166

(57) ABSTRACT

The driving support device includes a processor configured to detect a stationary object present in front of the vehicle, and a first moving object moving toward the stationary object in front of the vehicle, as objects around the vehicle, and execute collision avoidance support control to support collision avoidance between the vehicle and the first moving object. When detecting, in addition to the stationary object and the first moving object, a second moving object which is located farther from the vehicle than the first moving object in a lateral direction orthogonal to an extension direction of a driving lane in which the vehicle is traveling and which is moving toward the stationary object, the processor is configured to execute the collision avoidance support control based on a detection status of the second moving object.

### FIELD

The present disclosure relates to a driving support device, a driving support method, and a non-transitory recording medium.

### BACKGROUND

It is conventionally known that when a moving object (for example, a pedestrian, etc.) in front of a vehicle is likely to detour around a stationary object and enter the driving lane of the vehicle, control is executed on the vehicle for supporting collision avoidance with the moving object (for example, Patent Literature 1 to 3). As a specific example of such control, Patent Literature 1 describes that when it is judged that the time when the vehicle passes near a stationary object and the time when the moving object enters the driving lane are the same, the driver of the vehicle is notified of this fact.

### CITATION LIST

### Patent Literature

[PTL 1] Japanese U.S. Pat. No. 5,172,366

[PTL 2] Japanese Unexamined Patent Publication (Kokai) No. 2019-028951

[PTL 3] Japanese Unexamined Patent Publication (Kokai) No. 2024-063652

### SUMMARY

### Technical Problem

The technology described in Patent Literature 1 is based on the premise that when a stationary object is located in front of a moving object, the moving object will detour around the stationary object and enter the driving lane of the vehicle. However, in such a situation, the moving object may detour around the stationary object from the side opposite to the driving lane, and the moving object will not necessarily enter the driving lane. Thus, even if the moving object goes around the stationary object at a position away from the vehicle, an unnecessary warning is issued to the driver of the vehicle, and the driver may find the warning annoying.

In view of the problems described above, an object of the present disclosure is to appropriately support collision avoidance between a vehicle and a moving object by accurately predicting the route of a moving object moving toward a stationary object in front of the vehicle.

### Solution to Problem

The summary of the present disclosure is as follows.
(1) A driving support device for supporting driving of a vehicle, comprising a processor: detect a stationary object present in front of the vehicle, and a first moving object moving toward the stationary object in front of the vehicle, as objects around the vehicle; and execute collision avoidance support control to support collision avoidance between the vehicle and the first moving object, wherein when detecting, in addition to the stationary object and the first moving object, a second moving object which is located farther from the vehicle than the first moving object in a lateral direction orthogonal to an extension direction of a driving lane in which the vehicle is traveling and which is moving toward the stationary object, the processor is configured to execute the collision avoidance support control based on a detection status of the second moving object.
(2) The driving support device described in above (1), wherein the processor is configured to relax an execution condition of the collision avoidance support control when the second moving object is detected, compared to when the second moving object is not detected.
(3) The driving support device described in above (1), wherein the processor is configured to execute the collision avoidance support control when the second moving object is detected.
(4) The driving support device described in above (1), wherein the processor is configured to judge whether a predetermined condition is satisfied based on the detection status of the second moving object, and relax an execution condition of the collision avoidance support control when it is judged that the predetermined condition is satisfied, compared to when it is judged that the predetermined condition is not satisfied.
(5) The driving support device described in above (1), wherein the processor is configured to judge whether a predetermined condition is satisfied based on the detection status of the second moving object, and execute the collision avoidance support control when it is judged that the predetermined condition is satisfied.
(6) The driving support device described in above (4) or (5), wherein the predetermined condition is that the second moving object is located on a side opposite to the stationary object from the driving lane in the lateral direction at a timing when the second moving object is detected.
(7) The driving support device described in above (4) or (5), wherein the processor is configured to judge whether the predetermined condition is satisfied based on a relative speed between the first moving object and the second moving object.
(8) The driving support device described in above (7), wherein the predetermined condition is that the second moving object is located on a side opposite to the stationary object from the driving lane in the lateral direction at a timing when the first moving object reaches the stationary object.
(9) The driving support device described in above (7), wherein the predetermined condition is that a distance between the first moving object and the second moving object in the extension direction of the driving lane is equal to or less than a predetermined value at a timing when the first moving object reaches the stationary object.
(10) The driving support device described in above (7), wherein the predetermined condition is that a movement speed of the second moving object is faster than a movement speed of the first moving object when the second moving object is located behind the first moving object at a timing when the first moving object and the second moving object are detected.
(11) The driving support device described in above (7), wherein the predetermined condition is that the second moving object catches up with the first moving object before the first moving object reaches the stationary object, when the second moving object is located behind the first moving object at a timing when the first moving object and the second moving object are detected.
(12) The driving support device described in above (7), wherein the predetermined condition is that a movement speed of the second moving object is slower than a movement speed of the first moving object when the second moving object is located ahead of the first moving object at a timing when the first moving object and the second moving object are detected.
(13) The driving support device described in above (7), wherein the predetermined condition is that the first moving object does not overtake the second moving object before the first moving object reaches the stationary object, when the second moving object is located ahead of the first moving object at a timing when the first moving object and the second moving object are detected.
(14) The driving support device described in any one of above (1) to (13), wherein the processor is configured to change an execution mode of the collision avoidance support control in accordance with a first estimated arrival time from when the first moving object is detected until when the first moving object reaches the stationary object.
(15) The driving support device described in any one of above (1) to (13), wherein the processor is configured to change an execution mode of the collision avoidance support control in accordance with a second estimated arrival time from when the second moving object is detected until the second moving object reaches the stationary object.
(16) The driving support device described in any one of above (1) to (13), wherein the processor is configured to change an execution mode of the collision avoidance support control in accordance with relative positions of the first moving object, the second moving object, and the stationary object.
(17) The driving support device described in any one of above (14) to (16), wherein the processor is configured to execute automatic steering of the vehicle as the collision avoidance support control, and the execution mode is at least one of a steering amount and a steering start timing of the automatic steering.
(18) The driving support device described in any one of above (1) to (17), wherein the processor is configured to execute automatic steering of the vehicle as the collision avoidance support control when a vehicle arrival time from when the first moving object and the second moving object are detected until the vehicle reaches the stationary object is equal to or longer than a predetermined time, and execute a warning to a driver of the vehicle as the collision avoidance support control when the vehicle arrival time is less than the predetermined time.
(19) A driving support method executed by a computer, comprising: detecting an object around a vehicle; and when detecting a stationary object present in front of the vehicle, a first moving object moving toward the stationary object, and a second moving object which is located farther from the vehicle than the first moving object in a lateral direction orthogonal to an extension direction of a driving lane in which the vehicle is traveling and which is moving toward the stationary object, executing collision avoidance control for supporting collision avoidance between the vehicle and the first moving object based on a detection status of the second moving object.
(20) A computer program, which cause a computer to: detect an object around a vehicle; and when detecting a stationary object present in front of the vehicle, a first moving object moving toward the stationary object, and a second moving object which is located farther from the vehicle than the first moving object in a lateral direction orthogonal to an extension direction of a driving lane in which the vehicle is traveling and which is moving toward the stationary object, execute collision avoidance control for supporting collision avoidance between the vehicle and the first moving object based on a detection status of the second moving object.

According to the present disclosure, it is possible to appropriately support collision avoidance between a vehicle and a moving object by accurately predicting the route of a moving object moving toward a stationary object in front of the vehicle.

### BRIEF DESCRIPTION OF DRAWINGS

FIG. 1 is a schematic configuration view of a driving support system including a driving support device according to an embodiment of the present disclosure.

FIG. 2 is a functional block diagram of a processor of the ECU.

FIG. 3 is a view showing whether collision avoidance support control is implemented for a vehicle in each driving situation.

FIG. 4 is a view showing whether collision avoidance support control is implemented for a vehicle in each driving situation.

FIG. 5 is a view showing whether collision avoidance support control is implemented for a vehicle in each driving situation.

FIG. 6 is a view showing whether collision avoidance support control is implemented for a vehicle in each driving situation.

FIG. 7 is a view showing whether collision avoidance support control is implemented for a vehicle in each driving situation.

FIG. 8 is a view showing whether collision avoidance support control is implemented for a vehicle in each driving situation.

FIG. 9 is a view showing whether collision avoidance support control is implemented for a vehicle in each driving situation.

FIG. 10 is a flowchart showing a control routine related to collision avoidance support control of the present embodiment.

### DESCRIPTION OF EMBODIMENTS

The embodiments of the present disclosure will be described in detail below with reference to the drawings. Note that in the following description, identical constituent elements have been assigned identical reference signs.

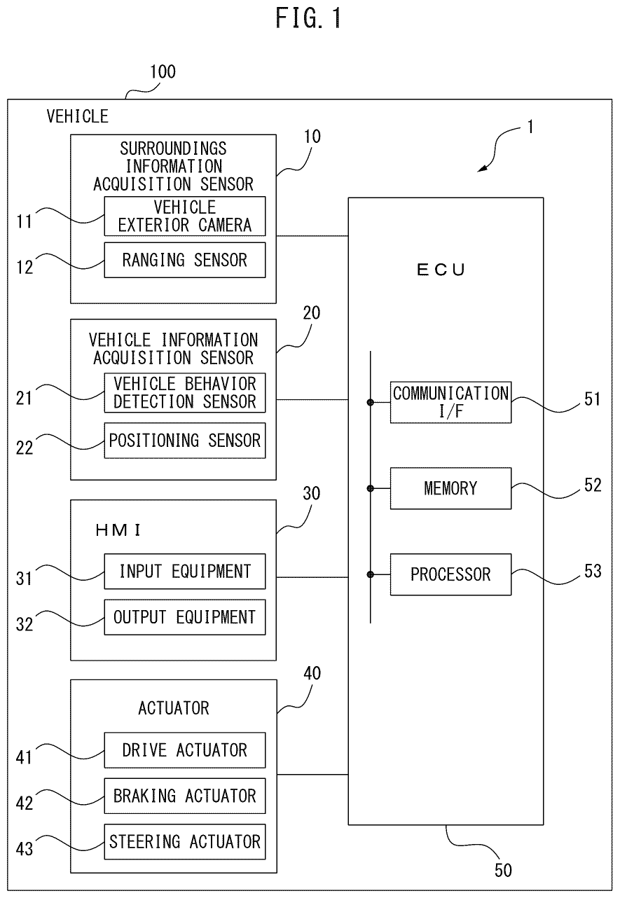

FIG. 1 is a schematic configuration view of a driving support system 1 including a driving support device according to an embodiment of the present disclosure. The driving support system 1 is mounted on a vehicle 100 and executes various controls to support the driving of the vehicle 100. In particular, in the present embodiment, the driving support system 1 predicts whether a moving object such as a pedestrian will jump out into the driving lane of the vehicle 100, and executes control to support collision avoidance with the moving object that is likely to jump out in front of the vehicle 100.

As shown in FIG. 1, the driving support system 1 includes a surroundings information acquisition sensor 10, a vehicle information acquisition sensor 20, a human machine interface (HMI) 30, an actuator 40, and an electronic control unit (ECU) 50. The surroundings information acquisition sensor 10, the vehicle information acquisition sensor 20, the HMI 30, and the actuator 40 are electrically connected to the ECU 50 via an in-vehicle network conforming to a standard such as a controller area network (CAN) or Ethernet.

The surroundings information acquisition sensor 10 acquires information regarding the surroundings of the vehicle 100 (host vehicle). The surroundings information acquisition sensor 10 generates surroundings data of the vehicle 100 (for example, image data, distance data, speed data, direction data, etc., of objects around the vehicle 100) at predetermined intervals and transmits the surroundings data to the ECU 50. The surroundings information acquisition sensor 10 includes, for example, a vehicle exterior camera 11 and a ranging sensor 12.

The vehicle exterior camera 11 captures the surroundings of the vehicle 100 and generates image data of the surroundings of the vehicle 100. In the present embodiment, the vehicle exterior camera 11 includes at least a front camera for capturing the front of the vehicle 100 and generating image data of the front of the vehicle 100. Note that a plurality of cameras may be provided in the vehicle 100 as the vehicle exterior camera 11. For example, in addition to the front camera, the vehicle exterior camera 11 may include a left side camera for capturing the left side of the vehicle 100 and generating image data of the left side of the vehicle 100, a right side camera for capturing the right side of the vehicle 100 and generating image data of the right side of the vehicle 100, a rear camera for capturing the rear of the vehicle 100 and generating image data of the rear of the vehicle 100, etc. The vehicle exterior camera 11 may be a monocular camera or a stereo camera.

The ranging sensor 12 detects the presence of an object around the vehicle 100 and measures the distance from the vehicle 100 to the object by irradiating the surroundings of the vehicle 100 with electromagnetic waves (millimeter waves or laser light) or ultrasonic waves. The ranging sensor 12 can also measure the speeds and directions of objects around the vehicle 100. Accordingly, the ranging sensor 12 generates distance data, speed data, direction data, etc., of objects around the vehicle 100. The ranging sensor 12 includes at least one of, for example, a millimeter wave radar, a lidar (LiDAR: Laser Imaging Detection And Ranging), and sonar (ultrasonic sensor).

The vehicle information acquisition sensor 20 acquires vehicle information (host vehicle information). The vehicle information acquisition sensor 20 generates vehicle data (behavior data, self-location data, etc., of the vehicle 100) related to the vehicle information at predetermined intervals and transmits the vehicle data to the ECU 50. The vehicle information acquisition sensor 20 includes, for example, a vehicle behavior detection sensor 21 and a positioning sensor 22.

The vehicle behavior detection sensor 21 detects the behavior (travel state) of the vehicle 100, and generates behavior data of the vehicle 100. The vehicle behavior detection sensor 21 includes, for example, at least one of a vehicle speed sensor for detecting the speed of the vehicle 100, an acceleration sensor for detecting the acceleration of the vehicle 100, a yaw rate sensor for detecting the rate of change (yaw rate) of the yaw angle when the vehicle 100 turns, and a steering angle sensor for detecting the steering angle (the steering angle of the steered wheels) of the vehicle 100. Accordingly, the vehicle behavior detection sensor 21 generates speed data, acceleration data, yaw rate data, steering angle data, etc., of the vehicle 100 as the behavior data of the vehicle 100.

The positioning sensor 22 measures the self-location of the vehicle 100 and generates self-location data of the vehicle 100. For example, the positioning sensor 22 is a global navigation satellite system (GNSS) receiver. The GNSS receiver detects the current position of the vehicle 100 (for example, the latitude and longitude of the vehicle 100) based on positioning information obtained from a plurality (for example, equal to or greater than three) of positioning satellites. A specific example of a GNSS receiver is a GPS receiver.

The HMI 30 is provided in the vehicle cabin and transmits and receives information between the vehicle 100 and occupants (for example, a driver) of the vehicle 100. The HMI 8 includes, for example, input equipment 31 and output equipment 32.

The input equipment 31 receives input from an occupant of the vehicle 100. The input equipment 31 includes at least one of a touch panel, an operation button, an operation switch, and a microphone. The HMI 30 transmits input data input to the input equipment 31 by the occupant of the vehicle 100 to the ECU 50.

The output equipment 32 notifies the occupant of the vehicle 100. The output equipment 32 includes at least one of a display, a warning light, a speaker, a buzzer, and a vibration unit. The HMI 30 notifies the occupant of the vehicle 100 of information corresponding to a signal transmitted from the ECU 50 via the output equipment 32.

The actuator 40 operates the vehicle 100 in response to operations by the driver of the vehicle 100, instructions from the ECU 50, etc. The actuator 40 includes, for example, a drive actuator 41 for controlling the acceleration of the vehicle 100 via a drive device of the vehicle 100 (for example, at least one of an internal combustion engine and an electric motor), a braking actuator 42 for controlling the braking of the vehicle 100, and a steering actuator 43 for controlling the steering of the vehicle 100. The ECU 50 controls the actuator 40 to control the behavior of the vehicle 100 (for example, the acceleration, braking, and steering of the vehicle 100).

The ECU 50 executes various controls of the vehicle 100. As shown in FIG. 1, the ECU 50 includes a communication interface 51, a memory 52 and a processor 53. The communication interface 51 and the memory 52 are connected to the processor 53 via a signal line. In the present embodiment, one ECU 50 is provided, but a plurality of ECUs may be provided for various functions. In addition, the communication interface 51, the memory 52, and the processor 53 may be configured as one integrated circuit, or may be configured as separate circuits.

The communication interface 51 has an interface circuitry for connecting the ECU 50 to the in-vehicle network. The ECU 50 is connected to other in-vehicle devices via the communication interface 51. The communication interface 51 transmits signals received from the surroundings information acquisition sensor 10, the vehicle information acquisition sensor 20, the input equipment 31 of the HMI 30. Further, the communication interface 51 transmits the signal output from the processor 53 to the output equipment 32 of the HMI 30 and the actuator 40.

The memory 52 has, for example, volatile semiconductor memories (e.g., DRAM (Dynamic Random Access Memory), SRAM (Static Random Access Memory), etc.), and non-volatile semiconductor memories (e.g., ROM (Read Only Memory), EEPROM (Electrically Erasable Programmable Read Only Memory), a flash memory, etc.). The memory 52 stores temporary data, a computer program (a control program of the ECU 50) used for various processes by the processor 53, setting data of the ECU 50, log data, vehicle-information, etc.

The processor 53 has one or more CPU (Central Processing Unit) and its peripheral circuitry. The processor 53 executes a computer program stored in the memory 52. The processor 53 may further has other arithmetic circuits such as a logical arithmetic unit, a numerical arithmetic unit, or a graphic processing unit.

In the present embodiment, the ECU 50 functions as the driving support device for supporting the driving of the vehicle 100. In particular, in the present embodiment, the ECU 50 predicts whether a moving object such as a pedestrian will jump out into the driving lane of the vehicle 100, and executes control to support collision avoidance with the moving object that is likely to jump out in front of the vehicle 100. The ECU 50 is an example of a driving support device.

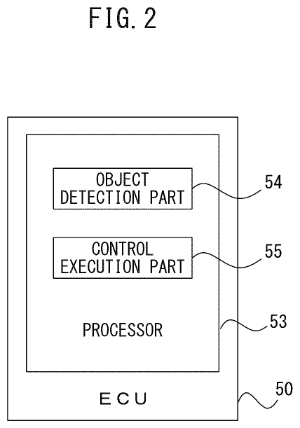

FIG. 2 is a functional block diagram of the processor 53 of the ECU 50. As shown in FIG. 2, the processor 53 has an object detection part 54 and a control execution part 55. The object detection part 54 and the control execution part 55 are functional modules that are realized by the processor 53 of the ECU 50 executing computer programs stored in the memory 52 of the ECU 50. Note that these functional modules may each be realized by a dedicated arithmetic circuit provided in the processor 53.

The object detection part 54 detects an object around the vehicle 100. For example, the object detection part 54 detects an object around the vehicle 100 based on the output of the surroundings information acquisition sensor 10. The object detection part 54 acquires identification information (for example, category, name, etc.), location information (for example, latitude and longitude), speed information (for example, relative speed with respect to the vehicle 100), etc., of the object based on the output of the surroundings information acquisition sensor 10. In order to acquire this information, an image analysis method such as a machine learning model may be used.

The control execution part 55 executes driving support control for supporting the driving of the vehicle 100. In particular, in the present embodiment, the control execution part 55 predicts whether a first moving object, which will be described later, will jump out into the driving lane of the vehicle 100, and executes collision avoidance support control (hereinafter also simply referred to as “collision avoidance support control”) for avoiding a collision between the vehicle 100 and the first moving object when there is a high possibility that the first moving object will jump out in front of the vehicle 100.

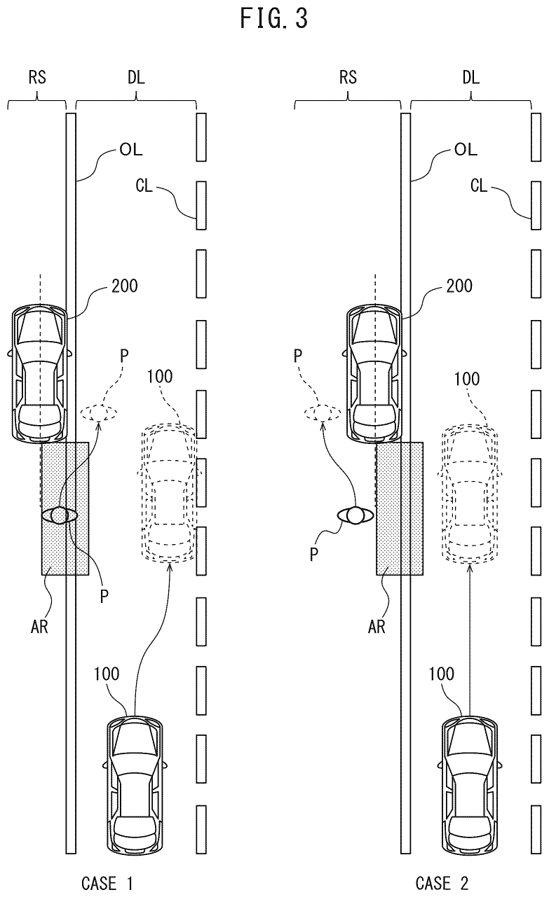

FIGS. 3 to 9 are views showing whether collision avoidance support control is implemented for the vehicle 100 in different driving situations (cases 1 to 14). In the examples of FIGS. 3 to 9, when collision avoidance support control is implemented, automatic steering of the vehicle 100 is executed as collision avoidance support control.

In cases 1 to 14, the vehicle 100 is traveling in a driving lane DL defined by a dashed white roadway centerline CL and a solid white outer lane line OL, and an object is present in a roadside strip RS outside the outer lane line OL (opposite the driving lane DL). In the present description, the extension direction of the driving lane DL in which the vehicle 100 is traveling, i.e., the direction along the driving lane DL, is referred to as the “vertical direction”, and the direction orthogonal to the vertical direction, i.e., the width direction of the driving lane DL, is referred to as the “lateral direction.”

In the present embodiment, the object detection part 54 detects an object located outside the outer lane line OL (opposite the driving lane DL) as an object around the vehicle 100. Specifically, the object detection part 54 detects an object located on the roadside strip, the shoulder, or the sidewalk as an object around the vehicle 100. Note that in the present embodiment, an object half or more of which is located outside the outer lane line OL is judged as an object located outside the outer lane line OL.

Such an object includes a stationary object (hereinafter simply referred to as a “stationary object”) in front of the vehicle 100, a moving object moving toward the stationary object, and an obstacle (hereinafter simply referred to as an “obstacle”) on the opposite side of the driving lane DL from the stationary object. The moving objects include a first moving object (hereinafter simply referred to as a “first moving object”) moving toward the stationary object in front of the vehicle 100, and a second moving object (hereinafter simply referred to as a “second moving object”) located farther from the vehicle 100 in the lateral direction than the first moving object and moving toward the stationary object.

The stationary object is an object which obstructs the vertical movement of the first moving object, such as a parked vehicle, a telephone pole, a signboard, a post, etc. In the present description, the driving lane DL side of a stationary object is referred to as the “inside”, and the opposite side of the stationary object from the driving lane DL is referred to as the “outside”.

The first moving object and the second moving object are objects which may move outside the outer lane line OL, such as a pedestrian, a runner, a bicycle, a motorbike, etc. In the present embodiment, the first moving object and the second moving object are objects that are shorter in length and width than the vehicle 100. The obstacle is an object that obstructs the lateral movement of the first moving object, such as a wall, a guardrail, a hedge, etc.

The control of the vehicle 100 in each case will be described in detail below. In case 1 and case 2 shown in FIG. 3, a parked vehicle 200 is present on the roadside strip RS, and the pedestrian P is moving toward the parked vehicle 200 in the same direction as the traveling direction of the vehicle 100. Furthermore, the parked vehicle 200 and the pedestrian P are located in front of the vehicle 100. In this case, the object detection part 54 detects a stationary object and a first moving object as objects around the vehicle 100. Specifically, the object detection part 54 detects the parked vehicle 200 as the stationary object and the pedestrian P as the first moving object.

In case 1, the pedestrian P is located inside a line (dashed line in the drawing, hereinafter also referred to as the “center line of the parked vehicle 200”) that passes through the center of the parked vehicle 200 and extends in the vertical direction. In this case, the distance of the route that the pedestrian P takes to detour around the parked vehicle 200 from the inside is shorter than the distance of the route that the pedestrian P takes to detour around the parked vehicle 200 from the outside. Thus, as indicated by the arrow in the drawing for case 1, the pedestrian P is highly likely to detour around the parked vehicle 200 from the inside in order to shorten the travel distance. Accordingly, since the route of the pedestrian P is predicted to be the inside route of the parked vehicle 200, there is a high risk that the pedestrian P will enter the driving lane DL.

Thus, the control execution part 55 judges that there is a high possibility that the pedestrian P will enter the driving lane DL, and executes collision avoidance support control. For example, the control execution part 55 executes automatic steering of the vehicle 100 as the collision avoidance support control. In this case, the control execution part 55 controls the steering actuator 43 so that the vehicle 100 moves away from the stationary object in the lateral direction, i.e., so that the vehicle 100 moves away from the outer lane line OL. As a result, as indicated by the arrow in the drawing of case 1, the vehicle 100 takes a course closer to the roadway center line CL than when the vehicle 100 travels straight. Thus, even if the pedestrian P enters the driving lane DL, a space is secured between the vehicle 100 and the pedestrian P, whereby a collision between the vehicle 100 and the pedestrian P is avoided.

On the other hand, in case 2, the pedestrian P is located outside the center line of the parked vehicle 200. In this case, the distance of the route that the pedestrian P takes to detour around the parked vehicle 200 from the outside is shorter than the distance of the route that the pedestrian P takes to detour around the parked vehicle 200 from the inside. Thus, as indicated by the arrow in the drawing of case 2, the pedestrian P is likely to detour around the parked vehicle 200 from the outside in order to shorten the travel distance. Accordingly, since the route of the pedestrian P is predicted to be the outside route of the parked vehicle 200, the risk of the pedestrian P entering the driving lane DL is reduced.

Thus, the control execution part 55 judges that the possibility of the pedestrian P entering the driving lane DL is low, and does not execute the collision avoidance support control. In this case, unless the driver of the vehicle 100 performs a steering operation, the vehicle 100 travels straight, as indicated by the arrow in the drawing of case 2. Therefore, since execution of the preventive control for avoiding a collision with the pedestrian P is avoided when the risk of collision with the pedestrian P is low, the driver of the vehicle 100 can be prevented from feeling annoyed.

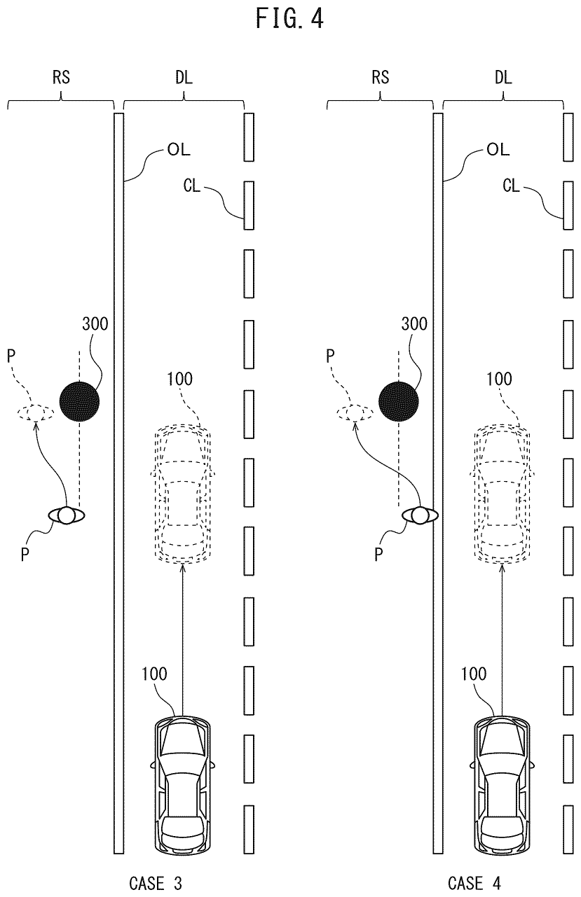

In case 3 and case 4 shown in FIG. 4, a telephone pole 300 is present on the roadside strip RS, and the pedestrian P is moving toward the telephone pole 300 in the same direction as the traveling direction of the vehicle 100. The telephone pole 300 and the pedestrian P are located in front of the vehicle 100. In this case, the object detection part 54 detects a stationary object and a first moving object as objects around the vehicle 100. Specifically, the object detection part 54 detects the telephone pole 300 as the stationary object, and the pedestrian P as the first moving object.

In case 3, the pedestrian P is located outside the line (the dashed line in the drawing, hereinafter also referred to as the “center line of the telephone pole 300”) that passes through the center of the telephone pole 300 and extends in the vertical direction. In this case, the distance of the route that the pedestrian P takes to detour around the telephone pole 300 from the outside is shorter than the distance of the route that the pedestrian P takes to detour around the telephone pole 300 from the inside. Thus, as indicated by the arrow in the drawing of case 3, the pedestrian P is highly likely to detour around the telephone pole 300 from the outside in order to shorten the travel distance. Accordingly, since the route of the pedestrian P is predicted to be the outside route of the telephone pole 300, the risk of the pedestrian P entering the driving lane DL is reduced.

Thus, the control execution part 55 judges that the possibility of the pedestrian P entering the driving lane DL is low, and does not execute the collision avoidance support control. In this case, unless the driver of the vehicle 100 performs a steering operation, the vehicle 100 travels straight, as indicated by the arrow in the drawing of case 3. Therefore, since execution of the preventive control for avoiding a collision with the pedestrian P is avoided when the risk of collision with the pedestrian P is low, the driver of the vehicle 100 can be prevented from feeling annoyed.

In case 4, the pedestrian P is located inside the center line of the telephone pole 300. In this case, the distance of the route that the pedestrian P takes to detour around the telephone pole 300 from the inside is shorter than the distance of the route that the pedestrian P takes to detour around the telephone pole 300 from the outside. However, for a small stationary object such as the telephone pole 300, the difference between the distance of the inner route and the distance of the outer route is smaller than that for a large stationary object such as the parked vehicle 200. Furthermore, the pedestrian P usually recognizes the outer route far from the driving lane DL as a safer route than the inner route close to the driving lane DL. Thus, in case 4, the motivation of the pedestrian P to adopt the inner route is low, and therefore the risk that the pedestrian P will enter the driving lane DL is also low.

Thus, the control execution part 55 judges that the possibility of the pedestrian P entering the driving lane DL is low, and does not execute the collision avoidance support control. In this case, unless the driver of the vehicle 100 performs a steering operation, the vehicle 100 travels straight, as indicated by the arrow in the drawing of case 4. Therefore, since execution of the preventive control for avoiding a collision with the pedestrian P is avoided when the risk of collision with the pedestrian P is low, the driver of the vehicle 100 can be prevented from feeling annoyed.

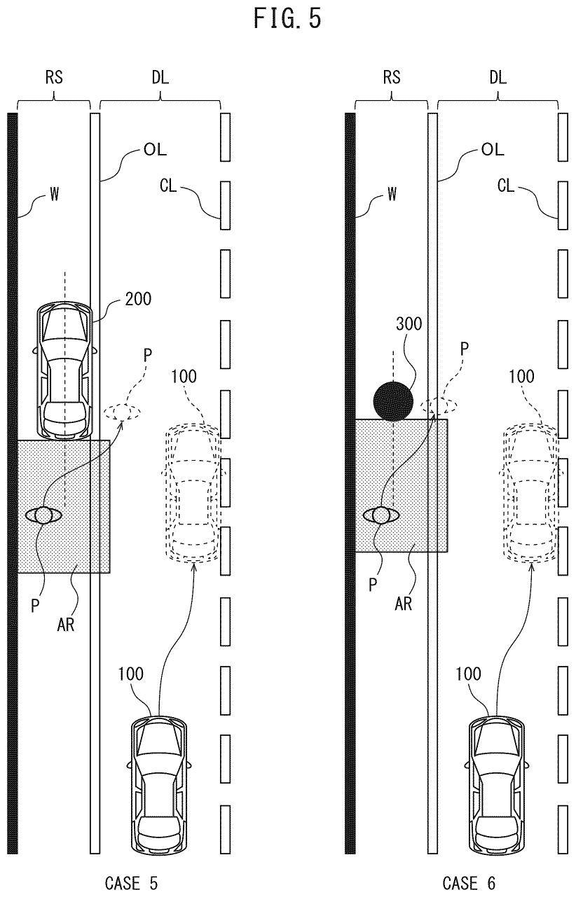

In case 5 shown in FIG. 5, the parked vehicle 200 is present on a roadside strip RS defined by an outer lane line OL and a wall W, and a pedestrian P is moving toward the parked vehicle 200 in the same direction as the traveling direction of the vehicle 100. The parked vehicle 200 and the pedestrian P are located in front of the vehicle 100. In this case, the object detection part 54 detects a stationary object, a first moving object, and an obstacle as objects around the vehicle 100. Specifically, the object detection part 54 detects the parked vehicle 200 as a stationary object, the pedestrian P as a first moving object, and the wall W as an obstacle.

In case 5, in the same manner as case 2, since the pedestrian P is located outside the center line of the parked vehicle 200, the distance of the route that the pedestrian P takes to detour around the parked vehicle 200 from the outside is shorter than the distance of the route that the pedestrian P takes to detour around the parked vehicle 200 from the inside. However, because the wall W is close to the parked vehicle 200, the route that the pedestrian P takes to detour around the parked vehicle 200 to the outside is blocked by the wall W. Thus, since the route of the pedestrian P is predicted to be the inside route of the parked vehicle 200, there is a high risk that the pedestrian P will enter the driving lane DL.

In case 6 shown in FIG. 5, a telephone pole 300 is present on a roadside strip RS defined by an outer lane line OL and a wall W, and a pedestrian P is moving toward the telephone pole 300 in the same direction as the traveling direction of the vehicle 100. The telephone pole 300 and the pedestrian P are located in front of the vehicle 100. In this case, the object detection part 54 detects a stationary object, a first moving object, and an obstacle as objects around the vehicle 100. Specifically, the object detection part 54 detects the telephone pole 300 as a stationary object, the pedestrian P as a first moving object, and the wall W as an obstacle.

In case 6, in the same manner as case 3, since the pedestrian P is located outside the center line of the telephone pole 300, the distance of the route that the pedestrian P takes to detour around the telephone pole 300 from the outside is shorter than the distance of the route that the pedestrian P takes to detour around the telephone pole 300 from the inside. However, because the wall W is close to the telephone pole 300, the route that the pedestrian P takes to detour around the telephone pole 300 to the outside is blocked by the wall W. Thus, since the route of the pedestrian P is predicted to be the inside route of the telephone pole 300, there is a high risk that the pedestrian P will enter the driving lane DL.

Therefore, in cases 5 and 6, the control execution part 55 judges that there is a high possibility that the pedestrian P will enter the driving lane DL, and executes the collision avoidance support control. Specifically, in the same manner as case 1, the automatic steering of the vehicle 100 is executed, and the vehicle 100 takes a course on the roadway center line CL side so as to move away from the stationary object. As a result, even if the pedestrian P enters the driving lane DL, a space is secured between the vehicle 100 and the pedestrian P, whereby a collision between the vehicle 100 and the pedestrian P is avoided.

In case 5, even when the pedestrian P is located inside the center line of the parked vehicle 200, the control execution part 55 judges that there is a high possibility that the pedestrian P will enter the driving lane DL and executes the collision avoidance support control. Likewise, in case 6, even when the pedestrian P is located inside the center line of the telephone pole 300, the control execution part 55 judges that there is a high possibility that the pedestrian P will enter the driving lane DL and executes the collision avoidance support control.

As can be understood from cases 1 and 2 described above, when the size of the stationary object is equal to or larger than a predetermined threshold, the control execution part 55 judges whether to execute the collision avoidance support control based on the positional relationship between the stationary object and the first moving object. In this case, when the first moving object is located within the predetermined support execution area AR, the control execution part 55 executes the collision avoidance support control, and when the first moving object is located outside the support execution area AR, the control execution part 55 does not execute the collision avoidance support control. The support execution area AR is an area inside a line that passes through the center of the stationary object and extends in the vertical direction (hereinafter also referred to as the “center line of the stationary object”), and is an area where the distance to the stationary object in the vertical direction is within a predetermined distance.

Conversely, the support execution area AR is not set in cases 3 and 4. Accordingly, the control execution part 55 does not set the support execution area AR when the size of the stationary object is less than the threshold. Thus, when the size of the stationary object is less than the threshold, the control execution part 55 does not execute the collision avoidance support control regardless of the positional relationship between the stationary object and the first moving object.

Furthermore, as can be understood from cases 5 and 6, the control execution part 55 executes the collision avoidance support control based on the detection status of the obstacle, regardless of the size of the stationary object. The control execution part 55 relaxes the execution condition of the collision avoidance support control when an obstacle is detected, compared to when the obstacle is not detected. For example, as shown in FIG. 5, when an obstacle is detected, the control execution part 55 expands the support execution area AR so that the area outside the center line of the stationary object is included in the support execution area AR.

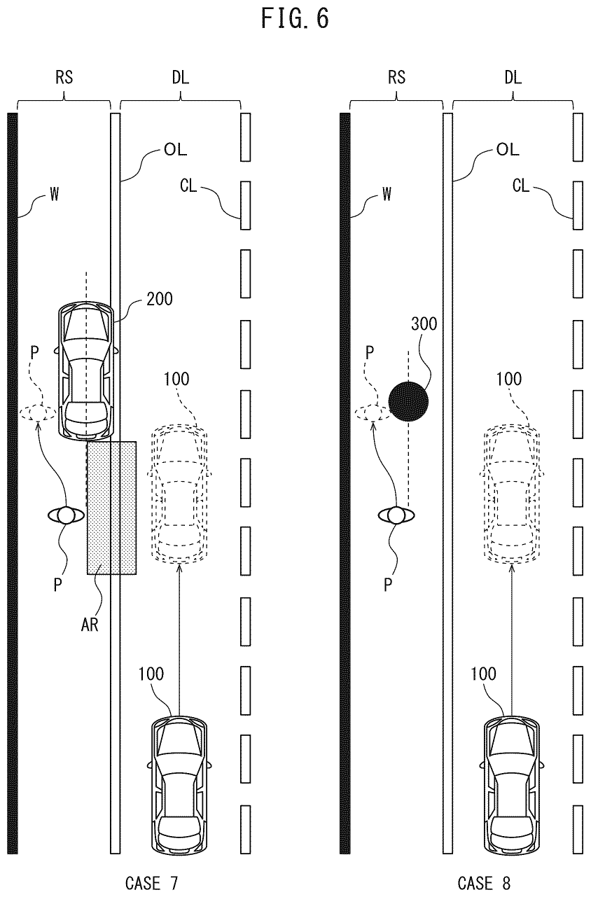

However, factors that determine the route of a first moving object such as the pedestrian P are not limited to the positional relationship between a stationary object and the first moving object, the size of the stationary object, and the presence or absence of an obstacle. A case in which the first moving object selects an outer route even if an obstacle is present outside the stationary object will be described below with reference to FIG. 6.

In case 7 shown in FIG. 6, in the same manner as case 5, the object detection part 54 detects the parked vehicle 200 as a stationary object, detects the pedestrian P as a first moving object, and detects the wall W as an obstacle. The positional relationship between the parked vehicle 200 and the pedestrian P in case 7 is similar to that in case 5. Meanwhile, unlike case 5, in case 7, since the wall W is spaced from the parked vehicle 200, the pedestrian P can pass outside the parked vehicle 200 (between the parked vehicle 200 and the wall W). Thus, since the route of the pedestrian P is predicted to be the outside route of the parked vehicle 200, the risk of the pedestrian P entering the driving lane DL is reduced.

In case 8 shown in FIG. 6, in the same manner as case 6, the object detection part 54 detects the telephone pole 300 as a stationary object, detects the pedestrian P as a first moving object, and detects the wall W as an obstacle. The positional relationship between the telephone pole 300 and the pedestrian P in case 8 is similar to that in case 6. On the other hand, unlike case 6, in case 8, since the wall W is spaced from the telephone pole 300, the pedestrian P can pass outside the telephone pole 300 (between the telephone pole 300 and the wall W). Thus, since the route of the pedestrian P is predicted to be the outside route of the telephone pole 300, the risk of the pedestrian P entering the driving lane DL is reduced.

Thus, in cases 7 and 8, the control execution part 55 judges that the possibility of the pedestrian P entering the driving lane DL is low, and does not execute the collision avoidance support control. As a result, since execution of the preventive control for avoiding a collision with the pedestrian P is avoided when the risk of collision with the pedestrian P is low, the driver of the vehicle 100 can be prevented from feeling annoyed.

Note that in case 7, since the size of the stationary object (the parked vehicle 200) is equal to or larger than the threshold, the support execution area AR is set as an area inside the center line of the stationary object, in the same manner as in cases 1 and 2. Thus, when the pedestrian P is located within the support execution area AR, the control execution part 55 judges that the pedestrian P is highly likely to enter the driving lane DL, in the same manner as in case 1, and executes the collision avoidance support control. Conversely, in case 8, since the size of the stationary object (telephone pole 300) is less than the threshold, the support execution area is not set, in the same manner as in cases 3 and 4. Thus, even if the pedestrian P is located inside the center line of the telephone pole 300, the control execution part 55 judges that the pedestrian P is unlikely to enter the driving lane DL, in the same manner as in case 4, and does not execute the collision avoidance support control.

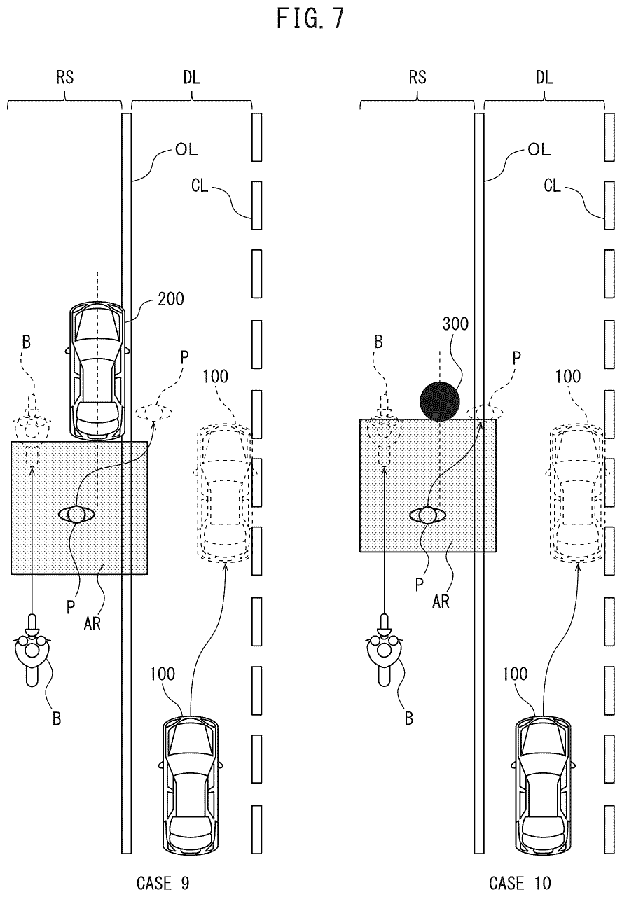

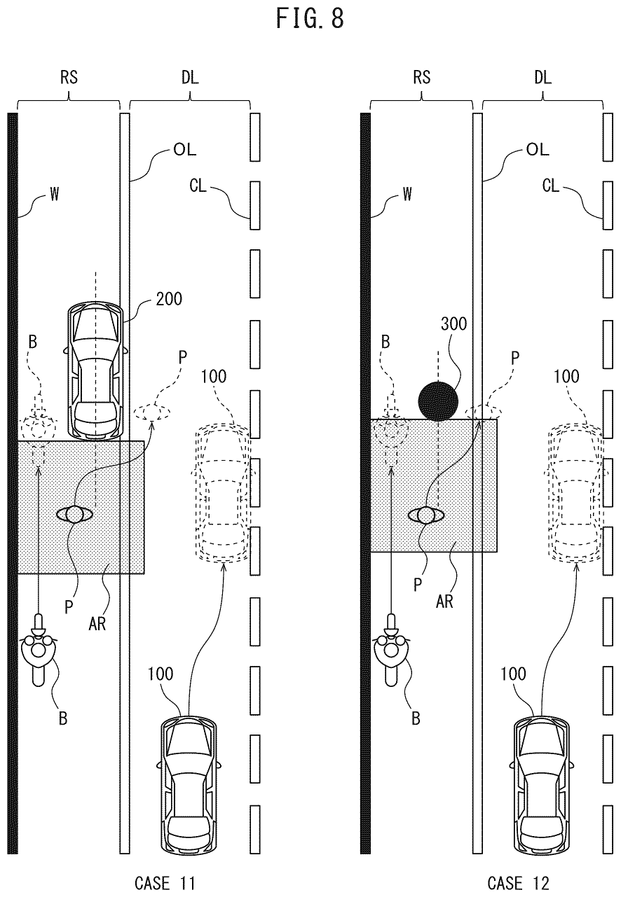

Furthermore, even if there is a space outside the stationary object through which the first moving object can pass, the first moving object need not necessarily pass through this space. Cases in which the first moving object selects an inner route even if such a space exists will be described below with reference to FIGS. 7 and 8.

In case 9 shown in FIG. 7, the parked vehicle 200 is present on the roadside strip RS, and the pedestrian P and a bicycle B are moving toward the parked vehicle 200 in the same direction as the traveling direction of the vehicle 100. Furthermore, the parked vehicle 200, the pedestrian P, and the bicycle B are located in front of the vehicle 100. In this case, the object detection part 54 detects a stationary object, a first moving object, and a second moving object as objects around the vehicle 100. Specifically, the object detection part 54 detects the parked vehicle 200 as a stationary object, the pedestrian P as a first moving object, and the bicycle B as a second moving object.

In case 9, in the same manner as case 2, the pedestrian P is located outside the center line of the parked vehicle 200, and the distance of the route that the pedestrian P takes to detour around the parked vehicle 200 from the outside is shorter than the distance of the route that the pedestrian P takes to detour around the parked vehicle 200 from the inside. However, since the bicycle B is about to pass the outside of the parked vehicle 200, the pedestrian P is likely to detour around the parked vehicle 200 from the inside out of fear of collision with the bicycle B. Accordingly, since the route of the pedestrian P is predicted to be the inside route of the parked vehicle 200, there is a high risk that the pedestrian P will enter the driving lane DL.

In case 10 shown in FIG. 7, the telephone pole 300 is present on the roadside strip RS, and the pedestrian P and the bicycle B are moving toward the telephone pole 300 in the same direction as the traveling direction of the vehicle 100. The telephone pole 300, the pedestrian P, and the bicycle B are located in front of the vehicle 100. In this case, the object detection part 54 detects a stationary object, a first moving object, and a second moving object as objects around the vehicle 100. Specifically, the object detection part 54 detects the telephone pole 300 as a stationary object, the pedestrian P as a first moving object, and the bicycle B as a second moving object.

In case 10, in the same manner as case 3, the pedestrian P is located outside the center line of the telephone pole 300, and the distance of the route that the pedestrian P takes to detour around the telephone pole 300 from the outside is shorter than the distance of the route that the pedestrian P takes to detour around the telephone pole 300 from the inside. However, since the bicycle B is about to pass outside the telephone pole 300, the pedestrian P is likely to detour around the telephone pole 300 from the inside out of fear of collision with the bicycle B. Accordingly, since the route of the pedestrian P is predicted to be the inside route of the telephone pole 300, there is a high risk that the pedestrian P will enter the driving lane DL.

Thus, in cases 9 and 10, the control execution part 55 judges that there is a high possibility that the pedestrian P will enter the driving lane DL, and executes the collision avoidance support control. Specifically, in the same manner as case 1, the automatic steering of the vehicle 100 is executed, and the vehicle 100 takes a course on the roadway center line CL side so as to move away from the stationary object. As a result, even if the pedestrian P enters the driving lane DL, a space is secured between the vehicle 100 and the pedestrian P, whereby a collision between the vehicle 100 and the pedestrian P is avoided.

In case 11 shown in FIG. 8, in the same manner as case 7, the object detection part 54 detects the parked vehicle 200 as a stationary object, detects the pedestrian as a first moving object, and detects the wall W as an obstacle. On the other hand, in case 11, unlike case 7, the object detection part 54 detects the bicycle B as a second moving object. Furthermore, the positional relationship between the parked vehicle 200, the pedestrian P, and the wall W in case 11 is similar to that in case 7. Specifically, there is a space between the parked vehicle 200 and the wall W through which the pedestrian P can pass. However, since the bicycle B is about to pass outside the parked vehicle 200, the pedestrian P is likely to detour around the parked vehicle 200 from the inside out of fear of collision with the bicycle B. Accordingly, since the route of the pedestrian P is predicted to be the inside route of the parked vehicle 200, there is a high risk that the pedestrian P will enter the driving lane DL.

In case 12 shown in FIG. 8, in the same manner as case 8, the object detection part 54 detects the telephone pole 300 as a stationary object, detects the pedestrian as a first moving object, and detects the wall W as an obstacle. On the other hand, in case 12, unlike case 8, the object detection part 54 detects the bicycle B as a second moving object. Furthermore, the positional relationship between the telephone pole 300, the pedestrian P, and the wall W in case 12 is similar to that in case 8. Specifically, there is a space between the telephone pole 300 and the wall W through which the pedestrian P can pass. However, since the bicycle B is about to pass outside the telephone pole 300, the pedestrian P is likely to detour around the telephone pole 300 from the inside out of fear of collision with the bicycle B. Accordingly, since the route of the pedestrian P is predicted to be on the inside of the telephone pole 300, there is a high risk that the pedestrian P will enter the driving lane DL.

Therefore, in cases 11 and 12, the control execution part 55 judges that there is a high possibility that the pedestrian P will enter the driving lane DL, and executes the collision avoidance support control. Specifically, in the same manner as case 1, the automatic steering of the vehicle 100 is executed, and the vehicle 100 takes a course on the roadway center line CL side so as to move away from the stationary object. As a result, even if the pedestrian P enters the driving lane DL, a space is secured between the vehicle 100 and the pedestrian P, whereby a collision between the vehicle 100 and the pedestrian P is avoided.

As can be understood from cases 9 to 12 described above, when the object detection part 54 detects a second moving object in addition to a stationary object and a first moving object, the control execution part 55 executes the collision avoidance support control based on the detection status of the second moving object. As a result, the route of the first moving object can accurately be predicted using information regarding the second moving object, and thus, it is possible to appropriately support collision avoidance between the vehicle 100 and the first moving object.

For example, the control execution part 55 judges whether the predetermined condition is satisfied based on the detection status of the second moving object, and relaxes the execution condition of the collision avoidance support control when it is judged that the predetermined condition is satisfied, compared to when it is judged that the predetermined condition is not satisfied. As a result, since the collision support control is more likely to be executed when there is a high possibility that the first moving object will pass inside the stationary object due to the presence of the second moving object, collision avoidance between the vehicle 100 and the first moving object can more appropriately be supported.

The predetermined condition is a condition that increases the possibility that the second moving object will prevent the first moving object from going around the stationary object from the opposite side of the driving lane DL of the vehicle 100, and is determined in advance. Specific examples of the predetermined condition include the following first to seventh conditions. If the predetermined condition is any of the second to seventh conditions, the control execution part 55 judges whether the predetermined condition is satisfied based on the relative speed between the first moving object and the second moving object. The first to seventh conditions will be described in detail below.

The first condition is that, at the timing when the second moving object is detected, the second moving object is located on the opposite side of the stationary object from the driving lane DL of the vehicle 100 in the lateral direction. When the first condition is satisfied, there is a high possibility that the second moving object will pass outside the stationary object, and thus, there is a high possibility that the second moving object will block the route outside the stationary object.

If the first condition is used, the control execution part 55 relaxes the execution condition of the collision avoidance support control when it is judged that the second moving object is located on the opposite side of the stationary object from the driving lane DL of the vehicle 100 in the lateral direction at the timing when the second moving object is detected (the first condition is satisfied). The control execution part 55 judges whether the first condition is satisfied based on the initial position of the second moving object (the position of the second moving object when the second moving object is detected). For example, when more than half of the second moving object is located outside the center line of the stationary object, the control execution part 55 judges that the second moving object is located on the opposite side of the stationary object from the driving lane DL of the vehicle 100 in the lateral direction. Furthermore, the control execution part 55 may judge that the second moving object is located on the opposite side of the stationary object from the driving lane DL of the vehicle 100 in the lateral direction when the entire second moving object is located outside the center line of the stationary object.

The second condition is that, at the timing when the first moving object reaches the stationary object, the second moving object is located on the opposite side of the stationary object from the driving lane DL of the vehicle 100 in the lateral direction. When the second condition is satisfied, there is an extremely high possibility that the route of the first moving object to the outside of the stationary object will be blocked by the second moving object.

If the second condition is used, the control execution part 55 relaxes the execution condition of the collision avoidance support control when it is judged that the second moving object is located on the opposite side of the stationary object from the driving lane DL of the vehicle 100 in the lateral direction at the timing when the first moving object reaches the stationary object (the second condition is satisfied). For example, the control execution part 55 judges whether the second condition is satisfied based on the relative speed between the first moving object and the second moving object, the position of the stationary object, the initial position of the first moving object (the position of the first moving object when the first moving object is detected), the initial position of the second moving object, and the moving direction of the second moving object.

The third condition is that the distance between the first moving object and the second moving object in the vertical direction is equal to or less than a predetermined value when the first moving object reaches the stationary object. When the third condition is satisfied, there is a high possibility that the route of the first moving object to the outside of the stationary object will be blocked by the second moving object.

If the third condition is used, the control execution part 55 relaxes the execution condition of the collision avoidance support control when it is judged that the distance between the first moving object and the second moving object in the vertical direction is equal to or less than a predetermined value at the timing when the first moving object reaches the stationary object (the third condition is satisfied). For example, the control execution part 55 calculates the distance between the first moving object and the second moving object in the vertical direction based on the relative speed between the first moving object and the second moving object, the position of the stationary object, the initial position of the first moving object, and the initial position of the second moving object, and judges whether the third condition is satisfied. The predetermined value is set to a value of, for example, equal to or less than 1 m. Note that the predetermined value may be zero. In other words, the third condition may be that the positions of the first moving object and the second moving object in the vertical direction are the same at the timing when the first moving object reaches the stationary object. In this case, when the first moving object and the second moving object overlap in the vertical direction, the positions of the first moving object and the second moving object in the vertical direction are judged to be the same.

The fourth condition is that the movement speed of the second moving object is faster than the movement speed of the first moving object when the second moving object is located behind the first moving object at the timing when the first moving object and the second moving object are detected. When the fourth condition is satisfied, the presence of the second moving object is likely to cause the first moving object to hesitate to move outside the stationary object.

When the fourth condition is used, the control execution part 55 relaxes the execution condition of the collision avoidance support control when it is judged that the movement speed of the second moving object is faster than that of the first moving object when the second moving object is located behind the first moving object at the timing when the first moving object and the second moving object are detected (the fourth condition is satisfied). For example, the control execution part 55 judges whether the fourth condition is satisfied based on the relative speed between the first moving object and the second moving object, the initial position of the first moving object, and the initial position of the second moving object.

The fifth condition is that the second moving object catches up with the first moving object before the first moving object reaches the stationary object, when the second moving object is located behind the first moving object at the timing the first moving object and the second moving object are detected. When the fifth condition is satisfied, the presence of the second moving object is highly likely to cause the first moving object to hesitate to move outside the stationary object.

If the fifth condition is used, the control execution part 55 relaxes the execution condition of the collision avoidance support control when it is judged that the second moving object will catch up with the first moving object before the first moving object reaches the stationary object when the second moving object is located behind the first moving object at the timing when the first moving object and the second moving object are detected (the fifth condition is satisfied). For example, the control execution part 55 judges whether the fifth condition is satisfied based on the relative speed between the first moving object and the second moving object, the position of the stationary object, the initial position of the first moving object, and the initial position of the second moving object.

The sixth condition is that the movement speed of the second moving object is slower than the movement speed of the first moving object when the second moving object is located ahead of the first moving object at the timing when the first moving object and the second moving object are detected. When the sixth condition is satisfied, the presence of the second moving object is likely to cause the first moving object to hesitate to move outside the stationary object.

When the sixth condition is used, the control execution part 55 relaxes the execution condition of the collision avoidance support control when it is judged that the movement speed of the second moving object is slower than that of the first moving object when the second moving object is located ahead of the first moving object at the timing when the first moving object and the second moving object are detected (the sixth condition is satisfied). For example, the control execution part 55 judges whether the sixth condition is satisfied based on the relative speed between the first moving object and the second moving object, the initial position of the first moving object, and the initial position of the second moving object.

The seventh condition is that the first moving object does not overtake the second moving object before the first moving object reaches the stationary object, when the second moving object is located ahead of the first moving object at the timing when the first moving object and the second moving object are detected. When the seventh condition is satisfied, the presence of the second moving object is highly likely to cause the first moving object to hesitate to move outside the stationary object.

If the seventh condition is used, the control execution part 55 relaxes the execution condition of the collision avoidance support control when it is judged that the first moving object does not overtake the second moving object before it reaches the stationary object, when the second moving object is located ahead of the first moving object at the timing when the first moving object and the second moving object are detected (the seventh condition is satisfied). For example, the control execution part 55 judges whether the seventh condition is satisfied based on the relative speed between the first moving object and the second moving object, the position of the stationary object, the initial position of the first moving object, and the initial position of the second moving object.

The control execution part 55 may relax the execution condition of the collision avoidance support control when it is judged that a plurality of conditions among the first condition to the seventh condition are satisfied. For example, the control execution part 55 may relax the execution condition of the collision avoidance support control when it is judged that, at the timing when the first moving object reaches the stationary object, the second moving object is located on the opposite side of the stationary object from the driving lane DL of the vehicle 100 in the lateral direction and the distance between the first moving object and the second moving object in the vertical direction is equal to or less than a predetermined value (the second and third conditions are satisfied).

Furthermore, a part of the first to seventh conditions may be omitted. For example, only one of the first to seventh conditions may be used. Additionally, a condition different from the first to seventh conditions may be used.

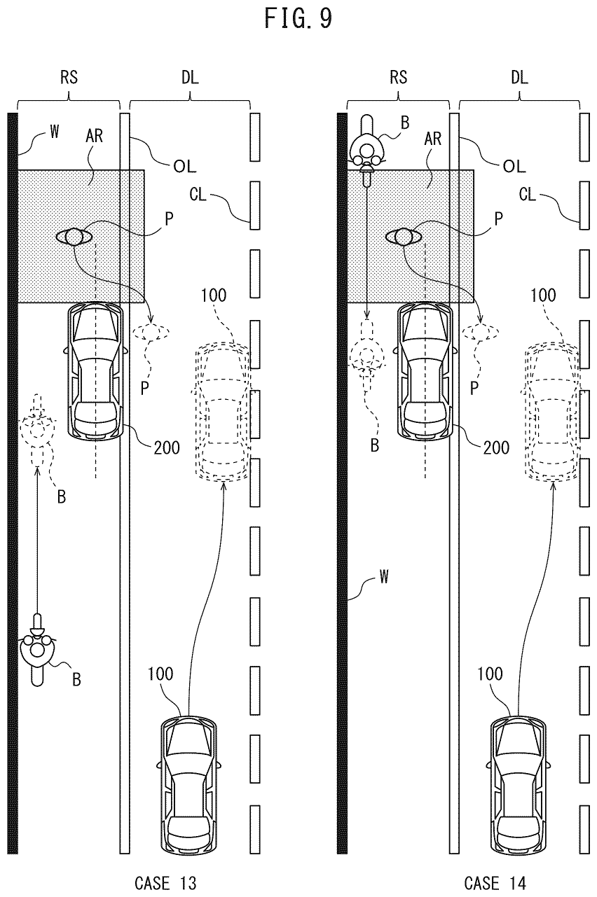

The first moving object does not necessarily move in the same direction as the traveling direction of the vehicle 100. Even if the traveling direction of the first moving object is opposite to the traveling direction of the vehicle 100, it is desirable to execute collision avoidance support control when there is a high possibility that the first moving object will enter the driving lane DL of the vehicle 100. FIG. 9 shows an example of a driving situation in which the traveling direction of the vehicle 100 and the traveling direction of the first moving object are opposite.

In case 13 shown in FIG. 9, in the same manner as case 11, the object detection part 54 detects the parked vehicle 200 as a stationary object, detects the pedestrian as a first moving object, detects the wall W as an obstacle, and detects the bicycle B as a second moving object. In case 13, the pedestrian P moving in the opposite direction to the traveling direction of the vehicle 100 is located outside the center line of the parked vehicle 200. Furthermore, in case 13, in the same manner as case 11, there is a space between the parked vehicle 200 and the wall W through which the pedestrian P can pass. However, since the bicycle B is approaching the parked vehicle 200 in the same direction as the traveling direction of the vehicle 100, the pedestrian P is likely to detour around the parked vehicle 200 from the inside out of fear of collision with the oncoming bicycle B. Accordingly, since the route of the pedestrian P is predicted to be the inside route of the parked vehicle 200, there is a high risk that the pedestrian P will enter the driving lane DL.

In case 14 shown in FIG. 9, unlike case 13, in addition to the first moving object, the second moving object is also moving in the opposite direction to the traveling direction of vehicle 100. In this case as well, it is highly likely that the pedestrian P will detour around the parked vehicle 200 from the inside out of fear of collision with bicycle B. Accordingly, since the route of the pedestrian P is predicted to be the inside route of the parked vehicle 200, there is a high risk that the pedestrian P will enter driving lane DL.

Therefore, in cases 13 and 14, the control execution part 55 judges that there is a high possibility that the pedestrian P will enter the driving lane DL, and executes collision avoidance support control to support collision avoidance of the vehicle 100. Specifically, in the same manner as case 1, the automatic steering of the vehicle 100 is executed, and the vehicle 100 takes a course on the roadway center line CL side so as to move away from the stationary object. As a result, even if the pedestrian P enters the driving lane DL, a space is secured between the vehicle 100 and the pedestrian P, whereby a collision between the vehicle 100 and the pedestrian P is avoided. Furthermore, in case 14, even if the pedestrian P is moving in the same direction as the vehicle 100, the control execution part 55 judges that there is a high possibility that the pedestrian P will enter the driving lane DL, and executes collision avoidance support control to support the collision avoidance of the vehicle 100.

Thus, as can be understood from cases 11 to 14, the movement directions of the first moving object and the second moving object do not affect the judgment of whether to execute the collision avoidance support control. This also applies to cases 1 to 10.

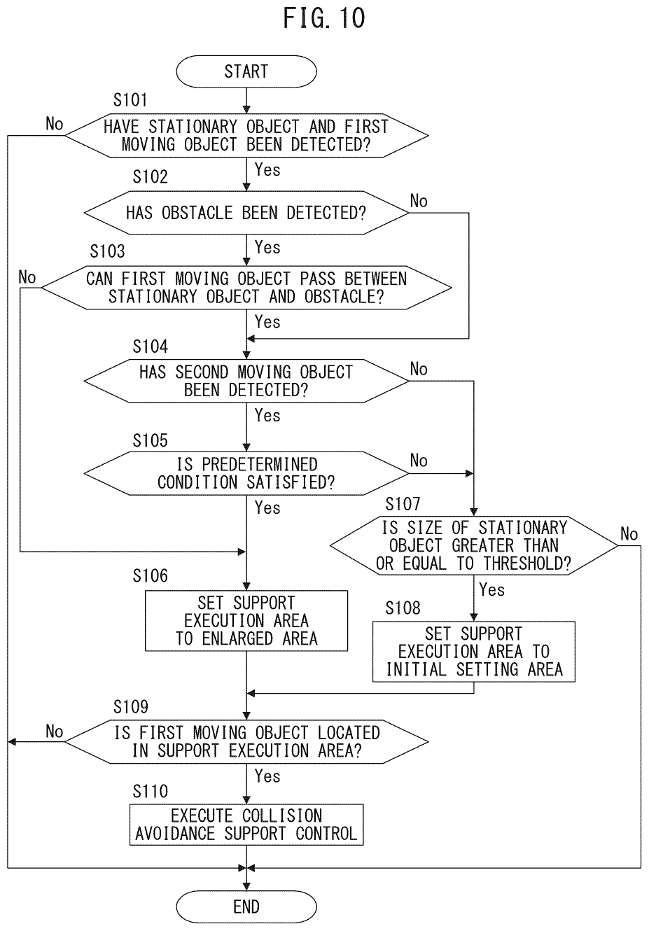

The flow of processing for executing the collision avoidance support control described above will be described below with reference to FIG. 10. FIG. 10 is a flowchart showing a control routine related to the collision avoidance support control of the present embodiment. This control routine is repeatedly executed by the processor 53 of the ECU 50 in accordance with the computer program stored in the memory 52 of the ECU 50, for example.

First, in step S101, the control execution part 55 of the processor 53 judges whether a stationary object and a first moving object have been detected by the object detection part 54 of the processor 53. When it is judged that at least one of the stationary object and the first moving object has not been detected, this control routine ends. On the other hand, when it is judged that the stationary object and the first moving object have been detected, this control routine proceeds to step S102.

In step S102, the control execution part 55 judges whether an obstacle has been detected by the object detection part 54. When it is judged that an obstacle has been detected, this control routine proceeds to step S103.

In step S103, the control execution part 55 judges whether the first moving object can pass between the stationary object and the obstacle. For example, the control execution part 55 judges whether the first moving object can pass between the stationary object and the obstacle by comparing the lateral distance between the stationary object and the obstacle with the size (lateral length) of the first moving object.

When it is judged that the first moving object cannot pass between the stationary object and the obstacle (for example, cases 5 and 6 of FIG. 5), the control routine proceeds to step S106. In step S106, the control execution part 55 relaxes the execution condition of the collision avoidance support control. Specifically, the control execution part 55 sets the support execution area AR to a predetermined enlarged area. The enlarged area includes the area inside the center line of the stationary object and the area outside the center line of the stationary object.

On the other hand, when it is judged in step S103 that the first moving object can pass between the stationary object and the obstacle, the control routine proceeds to step S104. Further, when it is judged in step S102 that the obstacle is not detected, the control routine skips step S103 and proceeds to step S104.

In step S104, the control execution part 55 judges whether a second moving object has been detected by the object detection part 54. When it is judged that a second moving object has been detected, this control routine proceeds to step S105.

In step S105, the control execution part 55 judges whether a predetermined condition is satisfied. For example, the control execution part 55 judges whether any one of the first to seventh conditions described above is satisfied. When it is judged that a predetermined condition is satisfied, the control routine proceeds to step S106. In step S106, the control execution part 55 sets the support execution area AR to the enlarged area.

On the other hand, when it is judged in step S104 that a second moving object has not been detected, or when it is judged in step S105 that a predetermined condition is not satisfied, this control routine proceeds to step S107.

In step S107, the control execution part 55 judges whether the size of the stationary object is equal to or greater than a predetermined threshold. When the lateral length of the stationary object is used as the size of the stationary object, the threshold is set to, for example, the vehicle width (total width) of a typical passenger vehicle. On the other hand, when the vertical length of the stationary object is used as the size of the stationary object, the threshold is set to, for example, the vehicle length (total length) of a typical passenger vehicle. The control execution part 55 may judge whether at least one or both of the lateral length and the vertical length of the stationary object are equal to or greater than a threshold.

When the size of the stationary object is judged to be less than the threshold value in step S107 (for example, cases 3 and 4 of FIG. 4 and case 8 of FIG. 6), it is predicted that the first moving object will detour around the stationary object from the opposite side of the driving lane DL of the vehicle 100. Thus, this control routine ends without executing the collision avoidance support control. On the other hand, when the size of the stationary object is judged to be equal to or greater than the threshold value in step S107 (for example, cases 1 and 2 of FIG. 3 and case 7 of FIG. 6), this control routine proceeds to step S108.

In step S108, the control execution part 55 sets the support execution area AR to a predetermined initial setting area. The initial setting area includes the area inside the center line of the stationary object, but does not include the area outside the center line of the stationary object.

After step S106 or step S108, the control routine proceeds to step S109. In step S109, the control execution part 55 judges whether the first moving object is located in the support execution area AR.

When it is judged in step S109 that the first moving object is not located in the support execution area AR (for example, in case 2 of FIG. 3 and case 7 of FIG. 6), it is predicted that the first moving object will detour around the stationary object from the opposite side of the driving lane DL of the vehicle 100. Thus, this control routine ends without executing the collision avoidance support control.

On the other hand, when it is judged in step S109 that the first moving object is located in the support execution area AR (for example, in case 1 of FIG. 3, cases 5 and 6 of FIG. 5, and cases 9 to 14 of FIGS. 7 to 9), it is predicted that the first moving object will detour around the stationary object from the driving lane DL side of the vehicle 100. Thus, in step S110, the control execution part 55 executes the collision avoidance support control. After step S110, this control routine ends.

In the present embodiment, the control execution part 55 executes automatic steering of the vehicle 100 as the collision avoidance support control. In this case, the control execution part 55 controls the steering actuator 43 so that, for example, the vehicle 100 moves away from the stationary object in the lateral direction. However, the control execution part 55 may execute automatic deceleration of the vehicle 100 as the collision avoidance support control. In this case, the control execution part 55 controls the braking actuator 42 to, for example, decelerate the vehicle 100 in preparation for the first moving object jumping into the driving lane DL. Further, the control execution part 55 may issue a warning to the driver of the vehicle 100 as the collision avoidance support control. In this case, the control execution part 55 issues at least one of a visual warning and an audio warning to the driver of the vehicle 100 via, for example, the output equipment 32.

Furthermore, when there is insufficient time before the collision avoidance support control is started, the behavior of the vehicle 100 due to the automatic steering of the vehicle 100 may become unstable. Thus, the control execution part 55 may execute the automatic steering of the vehicle 100 as the collision avoidance support control when the vehicle arrival time from when the first moving object and the second moving object are detected until the vehicle 100 reaches the stationary object is equal to or longer than a predetermined time, and execute a warning to the driver of the vehicle 100 as collision the avoidance support control when the vehicle arrival time is shorter than the predetermined time. As a result, it is possible to support collision avoidance between the vehicle 100 and the first moving object while preventing the behavior of the vehicle 100 from becoming unstable.

Various modifications and variations of this control routine are possible. For example, if the judgement in step S105 is affirmative or if the judgement in step S103 is negative, this control routine may skip steps S106 and S109 and proceed to step S110. Accordingly, the control execution part 55 may execute the collision avoidance support control without setting the support execution area AR, when a predetermined condition such as the first to seventh conditions described above is satisfied. Furthermore, the control execution part 55 may execute the collision avoidance support control without setting the support execution area AR, when it is judged that the first moving object cannot pass between the stationary object and the obstacle.

Furthermore, step S105 may be omitted. Accordingly, the control execution part 55 may relax the execution condition of the collision avoidance support control when the second moving object is detected, compared to when the second moving object is not detected. Step S105 may be omitted, and step S110 may be executed when step S104 is affirmative. Accordingly, the control execution part 55 may execute the collision avoidance support control without setting the support execution area AR when the second moving object is detected.

Furthermore, step S107 may be omitted. Specifically, the control execution part 55 may set the support execution area AR to the initial setting area even when the size of the stationary object is less than the threshold, in the manner of cases 3 and 4 of FIG. 4. Furthermore, steps S102 and S103 may be omitted.

Though the preferred embodiments of the present disclosure have been described above, the present disclosure is not limited to these embodiments, and various modifications and changes can be made within the scope of the claims.

For example, the control execution part 55 may change the execution mode of the collision avoidance support control in accordance with a predetermined parameter related to the first moving object, the second moving object, or the stationary object. The execution mode of the collision avoidance support control is, for example, at least one of the steering amount and the steering start timing of the automatic steering of the vehicle 100.

The predetermined parameter is, for example, a first estimated arrival time from when the first moving object is detected to when the first moving object arrives at the stationary object. In this case, the control execution part 55 performs at least one operation of increasing the steering amount of the automatic steering and advancing the steering start timing of the automatic steering when the first estimated arrival time is short, compared to when the first estimated arrival time is long.

Further, the predetermined parameter may be a second estimated arrival time from when the second moving object is detected to when the second moving object arrives at the stationary object. In this case, the control execution part 55 performs at least one operation of increasing the steering amount of the automatic steering and advancing the steering start timing of the automatic steering when the second estimated arrival time is short, compared to when the second estimated arrival time is long.

Further, the predetermined parameter may be the relative positions of the first moving object, the second moving object, and the stationary object. In this case, in accordance with the relative positions of the first moving object, the second moving object, and the stationary object, the control execution part 55 performs at least one operation of increasing the steering amount of the automatic steering and advancing the steering start timing of the automatic steering when the collision risk between the vehicle 100 and the first moving object is high, compared to when the collision risk is low.

Note that the execution mode of the collision avoidance support control may be at least one of the deceleration amount and deceleration timing of the automatic deceleration of the vehicle 100, at least one of the warning intensity and warning timing of the warning issued to the driver of the vehicle 100, etc.

Furthermore, even when the collision avoidance support control is not executed, the traveling of the vehicle 100 may be controlled by the driving support system 1. In this case, in cases such as case 2 of FIG. 3, cases 3 and 4 of FIG. 4, and cases 7 and 8 of FIG. 6, the processor 53 of the ECU 50 controls the actuator 40 (in particular, the steering actuator 43) so that the vehicle 100 travels straight.

A server or the like which is provided outside the vehicle 100 and which is capable of communicating with the vehicle 100 may function as the driving support device. In this case, information for detecting an object around the vehicle 100, for example, the output of the surroundings information acquisition sensor 10, is transmitted from the vehicle 100 to the server, and the ECU 50 of the vehicle 100 controls the steering actuator 43 and the like based on instructions from the server so that collision avoidance support control is executed.

The computer program that causes a computer to realize the functions of each part of the processor 53 of the ECU 50 may be provided in a form stored in a computer-readable recording medium or in a form included in a computer program product. The computer-readable recording medium is, for example, a magnetic recording medium, an optical recording medium, or a semiconductor memory.

1. A driving support device for supporting driving of a vehicle, comprising a processor:
detect a stationary object present in front of the vehicle, and a first moving object moving toward the stationary object in front of the vehicle, as objects around the vehicle; and
execute collision avoidance support control to support collision avoidance between the vehicle and the first moving object, wherein
when detecting, in addition to the stationary object and the first moving object, a second moving object which is located farther from the vehicle than the first moving object in a lateral direction orthogonal to an extension direction of a driving lane in which the vehicle is traveling and which is moving toward the stationary object, the processor is configured to execute the collision avoidance support control based on a detection status of the second moving object.

2. The driving support device according to claim 1, wherein the processor is configured to relax an execution condition of the collision avoidance support control when the second moving object is detected, compared to when the second moving object is not detected.

3. The driving support device according to claim 1, wherein the processor is configured to execute the collision avoidance support control when the second moving object is detected.

4. The driving support device according to claim 1, wherein the processor is configured to judge whether a predetermined condition is satisfied based on the detection status of the second moving object, and relax an execution condition of the collision avoidance support control when it is judged that the predetermined condition is satisfied, compared to when it is judged that the predetermined condition is not satisfied.

5. The driving support device according to claim 1, wherein the processor is configured to judge whether a predetermined condition is satisfied based on the detection status of the second moving object, and execute the collision avoidance support control when it is judged that the predetermined condition is satisfied.

6. The driving support device according to claim 4, wherein the predetermined condition is that the second moving object is located on a side opposite to the stationary object from the driving lane in the lateral direction at a timing when the second moving object is detected.

7. The driving support device according to claim 4, wherein the processor is configured to judge whether the predetermined condition is satisfied based on a relative speed between the first moving object and the second moving object.

8. The driving support device according to claim 7, wherein the predetermined condition is that the second moving object is located on a side opposite to the stationary object from the driving lane in the lateral direction at a timing when the first moving object reaches the stationary object.

9. The driving support device according to claim 7, wherein the predetermined condition is that a distance between the first moving object and the second moving object in the extension direction of the driving lane is equal to or less than a predetermined value at a timing when the first moving object reaches the stationary object.

10. The driving support device according to claim 7, wherein the predetermined condition is that a movement speed of the second moving object is faster than a movement speed of the first moving object when the second moving object is located behind the first moving object at a timing when the first moving object and the second moving object are detected.

11. The driving support device according to claim 7, wherein the predetermined condition is that the second moving object catches up with the first moving object before the first moving object reaches the stationary object, when the second moving object is located behind the first moving object at a timing when the first moving object and the second moving object are detected.

12. The driving support device according to claim 7, wherein the predetermined condition is that a movement speed of the second moving object is slower than a movement speed of the first moving object when the second moving object is located ahead of the first moving object at a timing when the first moving object and the second moving object are detected.

13. The driving support device according to claim 7, wherein the predetermined condition is that the first moving object does not overtake the second moving object before the first moving object reaches the stationary object, when the second moving object is located ahead of the first moving object at a timing when the first moving object and the second moving object are detected.

14. The driving support device according to claim 1, wherein the processor is configured to change an execution mode of the collision avoidance support control in accordance with a first estimated arrival time from when the first moving object is detected until when the first moving object reaches the stationary object.

15. The driving support device according to claim 1, wherein the processor is configured to change an execution mode of the collision avoidance support control in accordance with a second estimated arrival time from when the second moving object is detected until the second moving object reaches the stationary object.

16. The driving support device according to claim 1, wherein the processor is configured to change an execution mode of the collision avoidance support control in accordance with relative positions of the first moving object, the second moving object, and the stationary object.

17. The driving support device according to claim 14, wherein the processor is configured to execute automatic steering of the vehicle as the collision avoidance support control, and the execution mode is at least one of a steering amount and a steering start timing of the automatic steering.

18. The driving support device according to claim 1, wherein the processor is configured to execute automatic steering of the vehicle as the collision avoidance support control when a vehicle arrival time from when the first moving object and the second moving object are detected until the vehicle reaches the stationary object is equal to or longer than a predetermined time, and execute a warning to a driver of the vehicle as the collision avoidance support control when the vehicle arrival time is less than the predetermined time.

19. A driving support method executed by a computer, comprising:
detecting an object around a vehicle; and
when detecting a stationary object present in front of the vehicle, a first moving object moving toward the stationary object, and a second moving object which is located farther from the vehicle than the first moving object in a lateral direction orthogonal to an extension direction of a driving lane in which the vehicle is traveling and which is moving toward the stationary object, executing collision avoidance control for supporting collision avoidance between the vehicle and the first moving object based on a detection status of the second moving object.

20. A non-transitory recording medium having recorded thereon a computer program, the computer program causing a computer to:
detect an object around a vehicle; and
when detecting a stationary object present in front of the vehicle, a first moving object moving toward the stationary object, and a second moving object which is located farther from the vehicle than the first moving object in a lateral direction orthogonal to an extension direction of a driving lane in which the vehicle is traveling and which is moving toward the stationary object, execute collision avoidance control for supporting collision avoidance between the vehicle and the first moving object based on a detection status of the second moving object.
